(19) United States
(12) Patent Application Publication
(10) Pub. No.: US 2015/0045208 A1
(43) Pub. Date: Feb. 12, 2015

(54) Catalysts For Thermo-Catalytic Conversion Of Biomass, And Methods Of Making and Using

(71) Applicant: KIOR, Inc., Houston, TX (US)

(72) Inventors: Bruce Adkins, League City, TX (US); Jerry Jon Springs, League City, TX (US); Ling Zhou, Houston, TX (US)

(73) Assignee: KIOR, Inc., Houston, TX (US)

(21) Appl. No.: 13/963,493

(22) Filed: Aug. 9, 2013

(51) Int. Cl. B01J 29/85

(52) U.S. Cl. CPC B01J 29/85
USPC 502/68

(57) ABSTRACT

Disclosed are catalyst compositions including zeolite and silica components, methods of making, and processes of using in the thermo-catalytic conversion of biomass. Such disclosed methods of making include treating the zeolite with phosphorous during formation of the catalyst rather than prior to or after catalyst formation.

### FIELD OF THE INVENTION

The presently disclosed and claimed inventive process(es), procedure(s), method(s), product(s), result(s) and/or concept(s) (collectively hereinafter referenced to as the “presently disclosed and claimed inventive concept(s)”) relates generally to zeolite-containing catalysts for use in catalytic cracking processes, and more particularly, to methods of making and processes for using such catalysts in the thermo-catalytic conversion of biomass to bio-oil.

### DESCRIPTION OF THE RELATED ART

With the rising costs and environmental concerns associated with fossil fuels, renewable energy sources have become increasingly important, and in particular, the production of renewable transportation fuels from the conversion of biomass feedstocks. Many different processes have been, and are being, explored for the conversion of biomass to biofuels and/or specialty chemicals. Some of the existing biomass conversion processes include, for example, combustion, gasification, slow pyrolysis, fast pyrolysis, liquefaction, and enzymatic conversion. The conversion products produced from these processes tend to be of low quality, containing high amounts of water and highly oxygenated hydrocarbonaceous compounds, making them difficult to separate into aqueous and hydrocarbonaceous phases. Also, these products usually require extensive secondary upgrading in order to be useful as transportation fuels.

Bio-oils produced from the thermo-catalytic conversion of biomass tend to be of better quality, with hydrocarbonaceous compounds having relatively low oxygen content, and which are generally separable by gravity separation into aqueous and hydrocarbonaceous phases.

While the use of conventional cracking catalysts, such as zeolite-containing FCC cracking catalysts, in the thermo-catalytic conversion of biomass can result in bio-oil products of superior quality to those produced from straight pyrolysis of biomass, such conventional catalytic systems can still suffer from insufficiently low yields, lower but still insufficiently high bio-oil oxygen levels, and elevated coke make.

Accordingly, there remains a need for an improved catalyst for the thermo-catalytic conversion of biomass which results in higher bio-oil yields and/or lower bio-oil oxygen levels and/or lower coke make.

### SUMMARY OF THE INVENTION

In accordance with an embodiment of the presently disclosed and claimed inventive concept(s), a method of making a biomass conversion catalyst is provided and comprises:

a) combining the following components in a mix vessel:
a phosphorous compound,
a zeolite,
a clay, and
an aqueous silica precursor to thereby form an aqueous slurry;

b) spray drying the aqueous slurry to thereby form spray dried particles; and

c) calcining the spray dried particles to thereby form the biomass conversion catalyst.

In accordance with another embodiment, the phosphorous compound can be in the aqueous form and the aqueous slurry can be formed by:
i) adding the phosphorous compound to the mix vessel;
ii) adding the zeolite to the phosphorous compound in the mix vessel thereby forming a mixture A;
iii) adding the clay to the mixture A thereby forming a mixture B; and
iv) adding the aqueous silica precursor to the mixture B thereby forming the aqueous slurry of step a).

In accordance with another embodiment, the phosphorous compound can be in the aqueous form and the aqueous slurry can be formed by:
i) adding the phosphorous compound to the mix vessel;
ii) adding the clay to the phosphorous compound in the mix vessel thereby forming a mixture C;
iii) adding the zeolite to the mixture C thereby forming a mixture D; and
iv) adding the aqueous silica precursor to the mixture D thereby forming the aqueous slurry of step a).

In accordance with another embodiment, the phosphorous compound can be in the aqueous form and the aqueous slurry can be formed by:
i) combining a portion of the phosphorous compound with the zeolite outside of the mix vessel thereby forming a mixture E;
ii) combining a portion of the phosphorous compound with the clay outside of the mix vessel thereby forming a mixture F;
ii) combining the mixtures E and F in the mix vessel thereby forming a mixture G; and
iv) adding the aqueous silica precursor to the mixture G in the mix vessel thereby forming the aqueous slurry of step a).

In accordance with another embodiment, the phosphorous compound can be in the aqueous form and the aqueous slurry can be formed by:
i) adding the phosphorous compound to the mix vessel;
ii) combining a portion of the aqueous silica precursor with the zeolite outside of the mix vessel thereby forming a mixture H;
iii) combining a portion of the aqueous silica precursor with the clay outside of the mix vessel thereby forming a mixture I; and
iv) adding the mixtures H and I to the phosphorous compound in the mix vessel thereby forming the aqueous slurry.

### BRIEF DESCRIPTION OF THE DRAWINGS

FIG. 1 is a plot of pore size distribution of Catalysts A-F derived from Nitrogen Adsorption-Desorption Isotherms.

FIG. 2 is a plot showing relative yield of bio-oils separately produced from the thermo-catalytic conversion of biomass in the presence of Catalysts A-G.

FIG. 3 is a plot showing relative oxygen in bio-oils separately produced from the thermo-catalytic conversion of biomass in the presence of Catalysts A-G.

FIG. 4 is a plot showing relative yield of bio-oil vs. relative yield of coke separately produced from the thermo-catalytic conversion of biomass in the presence of Catalysts A-G.

### DETAILED DESCRIPTION OF THE INVENTION

Before explaining at least one embodiment of the inventive concept(s) disclosed herein in detail, it is to be understood that the presently disclosed and claimed inventive concept(s), process(es), methodology(ies) and/or outcome(s) is not limited in its application to the details of construction and the arrangement of the components or steps or methodologies set forth in the following description or illustrated in the drawings. The presently disclosed and claimed inventive concept(s), process(es), methodology(ies) and/or outcome(s) disclosed herein is/are capable of other embodiments or of being practiced or carried out in various ways. Also, it is to be understood that the phraseology and terminology employed herein is for the purpose of description and should not be regarded as limiting the presently disclosed and claimed inventive concept(s), process(es), methodology(ies) and/or outcome(s) herein in any way. All terms used herein are intended to have their ordinary meaning unless otherwise provided.

Substantially sodium free as used herein to describe a silica precursor can mean the silica precursor either contains no sodium or can contain less than 1; or less than 0.5, or less than 0.1 wt % Na, on a dry basis.

Catalysts

The biomass conversion catalyst(s) described in the embodiments below can be in the form of particles and can comprise, consist of, or consist essentially of silica, clay, a zeolite and phosphorous. Such zeolite can comprise a member selected from the group consisting of: i) an 8 membered zeolite, ii) a 10 membered zeolite, iii) a 12 membered zeolite, iv) ZSM-5, v) USY, vi) mordenite, vii) ferrierite, viii) beta zeolite, and ix) mixtures thereof. The zeolite can comprise ZSM-5. The clay can be any clay suitable for use in a catalyst, and can be kaolin, and can comprise alumina. The zeolite and the alumina present in the clay can also each be promoted with a portion of the phosphorous and present in the biomass conversion catalyst as a phosphorous promoted zeolite and a phosphated alumina, respectively.

The biomass conversion catalyst(s) can also be free of or substantially free of amorphous alumina. In addition, the biomass conversion catalyst(s) can have a Davison Attrition Index less than about 5, and can have an apparent bulk density greater than about 0.70 g/ml.

The biomass conversion catalyst(s) of this embodiment can be prepared by a method comprising, consisting of, or consisting essentially of:

a) combining the following components in a mix vessel:

a phosphorous compound,

the zeolite,

the clay, and

an aqueous silica precursor to thereby form an aqueous slurry;

b) spray drying the aqueous slurry to thereby form spray dried particles; and

c) calcining the spray dried particles to thereby form the biomass conversion catalyst.

The aqueous slurry can comprise, consist of, or consist essentially of: in the range of from about 1 to about 20 wt %, or from about 5 to about 15 wt % of the phosphorous compound; in the range of from about 10 to about 40 wt %, or from about 20 to about 40 wt % of the zeolite; in the range of from about 30 to about 60 wt %, or from about 30 to about 50 wt % of the clay; and in the range of from about 10 to about 30 wt %, or from about 15 to about 25 wt % of the aqueous silica precursor. Also, the pH of the aqueous slurry can be from about 2 to about 4, or from about 2 to about 3.

The aqueous silica precursor can comprise, consist of, or consist essentially of silicic acid, polysilicic acid, and combinations thereof. Also, the aqueous silica precursor can also be substantially sodium free, as described above.

The phosphorous compound can comprise, consist of, or consist essentially of a member selected from the group consisting of monoammonium phosphate, diammonium phosphate, phosphoric acid, and combinations thereof.

The calcining of the spray dried particles in step c) can be at a temperature in the range of from about 300° C. to about 600° C., or from about 400° C. to about 550° C.

The zeolite can be promoted with phosphorous contained in the phosphorous compound to thereby form the phosphorous promoted zeolite. Also, the alumina of the clay can react with phosphorous contained in the phosphorous compound to thereby form the phosphated alumina.

In accordance with another embodiment, with the phosphorous compound in the aqueous form the aqueous slurry can be formed by the following method comprising, consisting of, or consisting essentially of:
i) adding the phosphorous compound to the mix vessel;
ii) adding the zeolite to the phosphorous compound in the mix vessel thereby forming a mixture A;
iii) adding the clay to the mixture A thereby forming a mixture B; and
iv) adding the aqueous silica precursor to the mixture B thereby forming the aqueous slurry of step a).

The pH of the mixtures A and B can each be from about 3 to about 7, or from about 3.5 to about 5.5. The mixture A, or the mixture B, or both the mixture A and the mixture B can be aged at a temperature of about 10 to about 50° C., or from about 20 to about 30° C. for a period ranging from about 1 minute to about 24 hours, or from about 30 minutes to about 2 hours.

In accordance with another embodiment, with the phosphorous compound in the aqueous form the aqueous slurry can be formed by the following method comprising, consisting of, or consisting essentially of:
i) adding the phosphorous compound to the mix vessel;
ii) adding the clay to the phosphorous compound in the mix vessel thereby forming a mixture C;
iii) adding the zeolite to the mixture C thereby forming a mixture D; and
iv) adding the aqueous silica precursor to the mixture D thereby forming the aqueous slurry of step a).

The pH of the mixtures C and D can each be from about 3 to about 7, or from about 3.5 to about 5.5. The mixture C, or the mixture D, or both the mixture C and the mixture D can be aged at a temperature of about 10 to about 50° C., or from about 20 to about 30° C. for a period ranging from about 1 minute to about 24 hours, or from about 30 minutes to about 2 hours.

In accordance with another embodiment, with the phosphorous compound in the aqueous form the aqueous slurry can be formed by the following method comprising, consisting of, or consisting essentially of:
i) combining a portion of the phosphorous compound with the zeolite outside of the mix vessel thereby forming a mixture E;
ii) combining a portion of the phosphorous compound with the clay outside of the mix vessel thereby forming a mixture F;
ii) combining the mixtures E and F in the mix vessel thereby forming a mixture G; and
iv) adding the aqueous silica precursor to the mixture G in the mix vessel thereby forming the aqueous slurry of step a).

The pH of the mixtures E, F, and G can each be from about 3 to about 7, or from about 3.5 to about 5.5. The mixture E, or the mixture F, or both the mixture E and the mixture F can be aged at a temperature of about 10 to about 50° C., or from about 20 to about 30° C. for a period ranging from about 1 minute to about 24 hours, or from about 30 minutes to about 2 hours.

In accordance with another embodiment, with the phosphorous compound in the aqueous form the aqueous slurry can be formed by the following method comprising, consisting of, or consisting essentially of:
i) adding the phosphorous compound to the mix vessel;
ii) combining a portion of the aqueous silica precursor with the zeolite outside of the mix vessel thereby forming a mixture H;
iii) combining a portion of the aqueous silica precursor with the clay outside of the mix vessel thereby forming a mixture I; and
iv) adding the mixtures H and I to the phosphorous compound in the mix vessel thereby forming the aqueous slurry of step a).

The pH of the mixtures H and I can each be from about 2 to about 4, or from about 2 to about 3. The mixture H, or the mixture I, or both the mixture H and the mixture I can be aged at a temperature of about 0 to about 20° C., or from about 0 to about 10° C. for a period ranging from about 1 minute to about 12 hours, or from about 30 minutes to about 2 hours.

In each of the previous catalyst preparation embodiments, any suitable acid can be used to adjust the pH to the desired level, and can include sulfuric acid, nitric acid, phosphoric acid, or combinations thereof.

The biomass conversion catalyst(s) of the above-described embodiments require a lower amount of silica binder to provide sufficient binding as compared to the biomass conversion catalysts disclosed in U.S. patent application Ser. No. 13/446,926 filed on Apr. 13, 2012 and in U.S. patent application Ser. No. 13/838,706 filed on Mar. 15, 2013, each of which are herein incorporated by reference in their entirety. Also, such biomass conversion catalyst(s) of the above-described embodiments exhibit excellent physical properties.

The biomass conversion catalyst(s) of the above-described embodiments exhibit excellent zeolite accessibility resulting in superior deoxygenation activity in biomass conversion.

Coke selectivity is tunable in such biomass conversion catalyst(s) due to the use of the catalytically inert silica binder.

The organic acid-resistance is enhanced due to such biomass conversion catalyst(s) being substantially free of amorphous alumina.

Biomass Conversion

The biomass material useful in the invention described herein can be any biomass capable of being converted to liquid and gaseous hydrocarbons.

Preferred are solid biomass materials comprising a cellulosic material, in particular lignocellulosic materials, because of the abundant availability of such materials, and their low cost. The solid biomass feed can comprise components selected from the group consisting of lignin, cellulose, hemicelluloses, and combinations thereof. Examples of suitable solid biomass materials include forestry wastes, such as wood chips and saw dust; agricultural waste, such as straw, corn stover, sugar cane bagasse, municipal waste, in particular yard waste, paper, and card board; energy crops such as switch grass, coppice, eucalyptus; and aquatic materials such as algae; and the like.

The biomass can be thermo-catalytically converted at elevated temperatures. In particular, the biomass can be converted in a conversion reactor containing any of the above described biomass conversion catalyst(s) to thereby produce a conversion reactor effluent comprising vapor conversion products and the catalyst. The conversion reactor effluent can also include unreacted biomass, coke, or char. The vapor conversion products comprise, consist of, or consist essentially of bio-oil and water. The conversion reactor can be operated at a temperature in the range of from about 200° C. to about 1000° C., or between about 250° C. and about 800° C. The conversion reactor can also be operated in the substantial absence of oxygen.

At least a portion of the vapor conversion products can be separated from the conversion reactor effluent, and at least a portion of the vapor conversion products thus separated can be condensed to form a condensate comprising bio-oil and water. The condensate is generally separable by gravity separation into the bio-oil and into an aqueous phase comprising water.

Optionally, at least a portion of the bio-oil can be separated from the condensate, also forming the aqueous phase comprising water and less than about 25 wt %, or less than about 15 wt % hydrocarbonaceous compounds. Such separation can be by any method capable of separating bio-oil from an aqueous phase, and can include, but is not limited to, centrifugation, membrane separation, gravity separation, and the like. Preferably, if separated, the condensate is separated by gravity separation in a settling vessel into the bio-oil and into the aqueous phase. The oxygen levels of the produced bio-oils can be less than about 20 wt % on a dry basis, or between about 4 to about 18 wt % on a dry basis.

### EXAMPLES

### Binder Preparation (Polysilicic Acid—PSA)

A sodium silicate solution was prepared by diluting a quantity of sodium silicate with deionized water.

The sodium silicate solution was contacted with ion exchange resin beads to exchange the sodium ions of the sodium silicate with H⁺ ions on the beads. The resulting PSA solution was substantially sodium free and contained 10.13 wt % SiO2.

### Example 1

### Catalyst Preparation

Preparation of Catalyst A

The following procedure was followed for the preparation of Catalyst A:
1) Monoammonium phosphate (MAP) was dissolved in water in a mix tank.
2) A bead milled ZSM-5 aqueous slurry was then added to the MAP solution in the mix tank.
3) Kaolin clay was then added to the mix tank and the mix tank contents were stirred for 30 minutes.
4) A portion of the PSA solution described above was then added to the mix tank. The pH of the mix tank contents was then maintained at or below 2 by adding HNO₃, as needed.
5) The contents of the mix tank were then spray dried forming spray dried particles.
6) The spray dried particles were then placed in a furnace and calcined at 300° C. for 3 hours followed by 550° C. for 6 hours, thereby forming Catalyst A which contained: 15 wt % silica; 39.6 wt % kaolin clay; 9 wt % P₂O₅; and 36.4 wt % ZSM-5.

Preparation of Catalysts B and C

The following procedure was followed for the preparation of each of Catalysts B and C:
1) Monoammonium phosphate (MAP) was dissolved in water in a mix tank.
2) Kaolin clay was then added to the MAP solution in the mix tank and the mix tank contents were stirred for 30 minutes.
3) A ZSM-5 aqueous slurry was then added to the mix tank and the mix tank contents were stirred for 30 minutes.
4) A portion of the PSA solution described above was then added to the mix tank. The pH of the mix tank contents was then maintained at or below 2 by adding HNO₃, as needed.
5) The contents of the mix tank were then spray dried forming spray dried particles.
6) The spray dried particles were then placed in a furnace and calcined at 300° C. for 3 hours followed by 550° C. for 6 hours, thereby forming Catalysts B and C. Catalyst B contained: 15 wt % silica; 39.6 wt % kaolin clay; 9 wt % P₂O₅; and 36.4 wt % ZSM-5; and Catalyst C contained: 23 wt % silica; 35.6 wt % kaolin clay; 5 wt % P₂O₅; and 36.4 wt % ZSM-5.

Preparation of Catalyst D

The following procedure was followed for the preparation of Catalyst D:
1) Monoammonium phosphate (MAP) was dissolved in water in a first mix tank.
2) A ZSM-5 aqueous slurry was then added to the MAP solution in the first mix tank and the first mix tank contents were stirred for 30 minutes.
3) Monoammonium phosphate (MAP) was dissolved in water in a second mix tank.
4) Kaolin clay was then added to the MAP solution in the second mix tank and the second mix tank contents were stirred for 30 minutes.
5) The second mix tank contents were then added to the first mix tank with mixing for 15 minutes.
6) A portion of the PSA solution described above was then added to the first mix tank with mixing for 10 minutes. The pH of the mix tank contents was maintained at or below 2 by adding HNO₃, as needed.
7) The contents of the mix tank were then spray dried forming spray dried particles.
8) The spray dried particles were then placed in a furnace and calcined at 300° C. for 3 hours followed by 550° C. for 6 hours, thereby forming Catalyst D which contained: 15 wt % silica; 39.6 wt % kaolin clay; 9 wt % P₂O₅; and 36.4 wt % ZSM-5.

Preparation of Catalyst E

The following procedure was followed for the preparation of Catalyst E:
1) A portion of the PSA solution described above was added to a first mix tank along with additional water.
2) A ZSM-5 aqueous slurry was then added to the PSA in the first mix tank and the first mix tank contents were stirred for 30 minutes.
3) A portion of the PSA solution described above, and additional water, were added to a second mix tank.
4) Kaolin clay was then added to the PSA in the second mix tank and the second mix tank contents were stirred for 30 minutes.
5) The second mix tank contents were then added to the first mix tank with mixing for 15 minutes.
6) MAP was then added to the first mix tank with mixing for 30 minutes. The pH of the mix tank contents was maintained at or below 2 by adding HNO₃, as needed.
7) The contents of the first mix tank were then spray dried forming spray dried particles.
8) The spray dried particles were then placed in a furnace and calcined at 300° C. for 3 hours followed by 550° C. for 6 hours, thereby forming Catalyst E which contained: 23 wt % silica; 35.6 wt % kaolin clay; 5 wt % P₂O₅; and 36.4 wt % ZSM-5.

Preparation of Base Case Catalyst F

ZSM-5 Phosphorous Pretreatment (P-ZSM-5 Preparation) for Base Case Catalyst F

ZSM-5 powder was slurried in water at 35% solids. Aqueous H₃PO₄ (56-85 wt % on a dry H₃PO₄ basis) was added to some of the ZSM-5 slurry. The components were mixed and pH was checked to be in the range of 1.8-2.5.

The pH of the slurry was adjusted to pH 4.0±0.2 with ammonium hydroxide solution (NH₄OH 29 wt %). The slurry was spray dried, and the resulting phosphated powder was calcined at 600° C. for 4 hours in a muffle furnace. The calcined P-ZSM-5 contained 9 wt % P₂O₅, based on the dry basis weight of the ZSM-5.

The calcined P-ZSM-5 was re-slurried in water at 35% solids and thoroughly milled and dispersed using a bead mill, forming a P-ZSM-5 slurry. The D50 was less than about 3.5 μm. The D90 was less than about 10 μm. The temperature was controlled so as not to exceed 55° C.

The following procedure was followed for the preparation of Catalyst F:
1) A portion of the PSA solution described above was added to a first mix tank along with additional water.
2) NH₄OH, tetrasodium pyrophosphate and the P-ZSM-5 slurry described above were added to a second mix tank forming a zeolite mixture.
3) The second mix tank contents were then added to the first mix tank.
4) Kaolin clay was then added to the contents of the first mix tank and the first mix tank contents were stirred for 5 minutes.
5) The contents of the first mix tank were then spray dried forming spray dried particles.
6) The spray dried particles were then placed in a furnace and calcined at 400° C. for 1 hour, without any water washing before or after calcination, thereby forming Catalyst F which contained: 28 wt % silica, 32 wt % kaolin clay, and 40 wt % P-ZSM-5.

### Example 2

### Catalyst Characterization

Fresh samples of catalysts A-F, and a commercially available Fluid Catalytic Cracking (FCC) catalyst containing ZSM-5 (referred to as Catalyst G) were analyzed for elemental composition and various physical properties, the results of which are shown in Tables 1 and 2 below.

TABLE 1

| Catalyst | Catalyst | Catalyst | Catalyst | |
|---|---|---|---|---|
| Properties | A | B | C | Method |
| Attrition | 4.41 | 3.99 | 2.13 | ASTM |
| by Air Jet | | | | D5757 |
| Apparent Bulk | 0.75 | 0.75 | 0.81 | ASTM |
| Density (ABD) | | | | B329 |
| Total Surface | 161.41 | 161.81 | 140.99 | BET plot, |
| Area (TSA) | | | | P/P0 = |
| | | | | .01-.10 |
| Meso Surface | 54.93 | 42.85 | 44.02 | t-plot, |
| Area (MSA) | | | | 3.5-5.0 Å |
| Micro Surface | 106.47 | 118.96 | 96.98 | ZSA = |
| Area (ZSA) | | | | TSA − MSA |
| wt % Al₂O₃ | 20.09 | 19.95 | 17.44 | Rigaku |
| wt % SiO₂ | 68.69 | 68.58 | 74.91 | XRF |
| wt % P₂O₅ | 9.39 | 9.38 | 5.02 | Model |
| wt % Na₂O | 0.04 | 0.11 | 0.22 | |

TABLE 2

| Catalyst | Catalyst | Catalyst | Catalyst | Catalyst | |
|---|---|---|---|---|---|
| Properties | D | E | F | G | Method |
| Attrition | 1.78 | 0.56 | 1.38 | — | ASTM |
| by Air Jet | | | | | D5757 |
| Apparent Bulk | 0.76 | 0.82 | 0.79 | 0.70 | ASTM |
| Density (ABD) | | | | | B329 |
| Total Surface | 140.39 | 142.18 | 146.83 | 125.12 | BET plot, |
| Area (TSA) | | | | | P/P0 = |
| | | | | | .01-.10 |
| Meso Surface | 41.48 | 40.96 | 21.20 | 33.23 | t-plot, |
| Area (MSA) | | | | | 3.5-5.0 Å |
| Micro Surface | 98.91 | 101.22 | 125.63 | 91.89 | ZSA = |
| Area (ZSA) | | | | | TSA − MSA |
| wt % Al₂O₃ | 19.88 | 18.88 | 16.76 | 23.88 | Rigaku |
| wt % SiO₂ | 69.06 | 73.92 | 78.42 | 63.20 | XRF |
| wt % P₂O₅ | 9.11 | 5.99 | 3.84 | 10.11 | Model |
| wt % Na₂O | 0.15 | 0.21 | 0.08 | 0.15 | |

Catalysts A-E demonstrated sufficient binding but with lower wt % silica as compared to base case Catalyst F. Also, as shown in Tables 1 and 2, Catalysts A-E exhibited excellent physical properties.

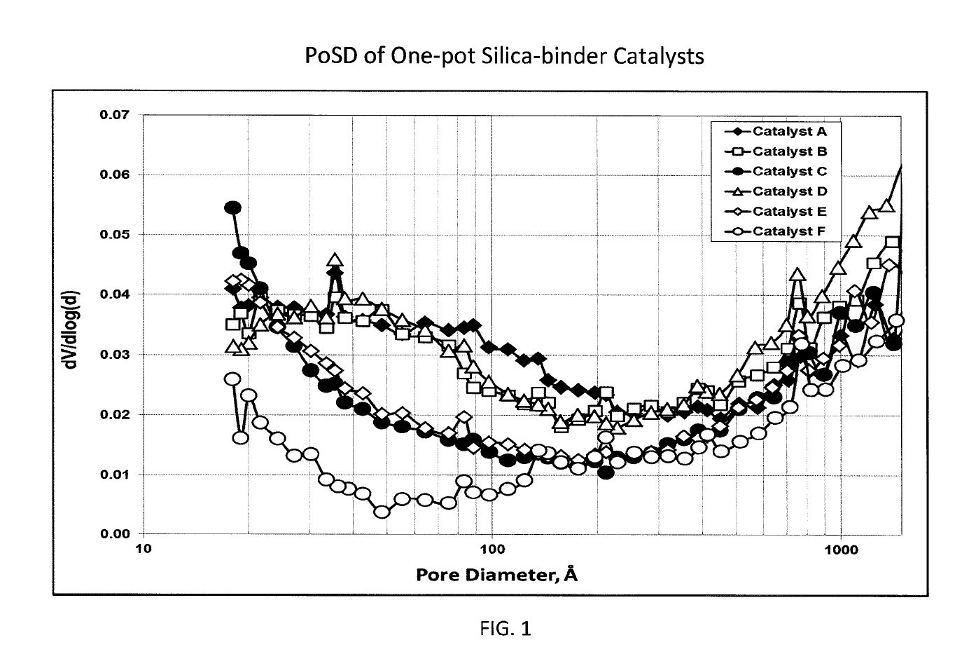

Catalysts A-F were subjected to Nitrogen adsorption-desorption isotherm testing per ASTM D4222; and the resulting pore size distribution (PoSD) for catalysts A-F are presented in FIG. 1. The catalysts A-E of the above-described embodiments show very different pore size distributions in the mesopores range of 2-20 nm from the catalyst F. In contrast to the very low mesopore volume (<0.01 cm³/g) of the catalyst F, the catalysts A, B, and D have mesopore volumes higher than 0.028 cm³/g, whereas the catalysts C and E have mesopore volumes below 0.022 cm³/g.

### Example 3

### Biomass Conversion Using Catalysts A-G in a Laboratory Scale Biomass Conversion Batch Testing Unit

Each of the catalysts A-G were separately used as catalysts in the thermo-catalytic conversion of southern yellow pine wood chips in a laboratory scale biomass conversion batch testing unit. The unit temperatures for the runs were each about 940° F. All runs were in the substantial absence of free oxygen. After separation of the product gases and vapors from the catalyst, the condensable portion of the product stream was condensed and allowed to gravity separate into aqueous and bio-oil phases.

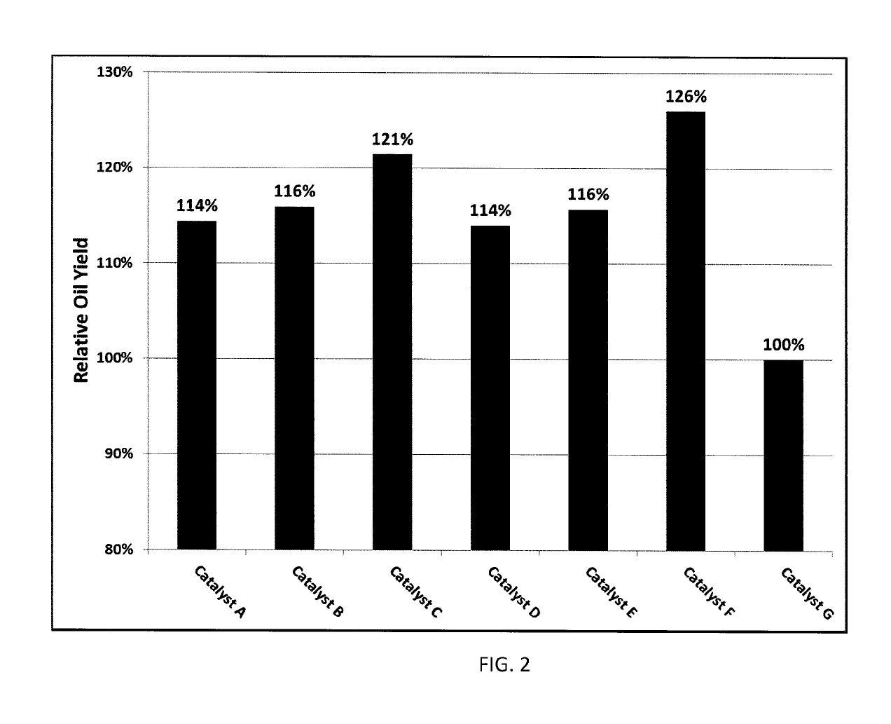

FIG. 2 is a plot of relative bio-oil yields resulting from the above described biomass conversion runs for each of Catalysts A-G, all relative to the oil yield for Catalyst G. FIG. 2 shows consistently higher bio-oil yields for Catalysts A-E of the above-described embodiments as compared to commercially available FCC Catalyst G.

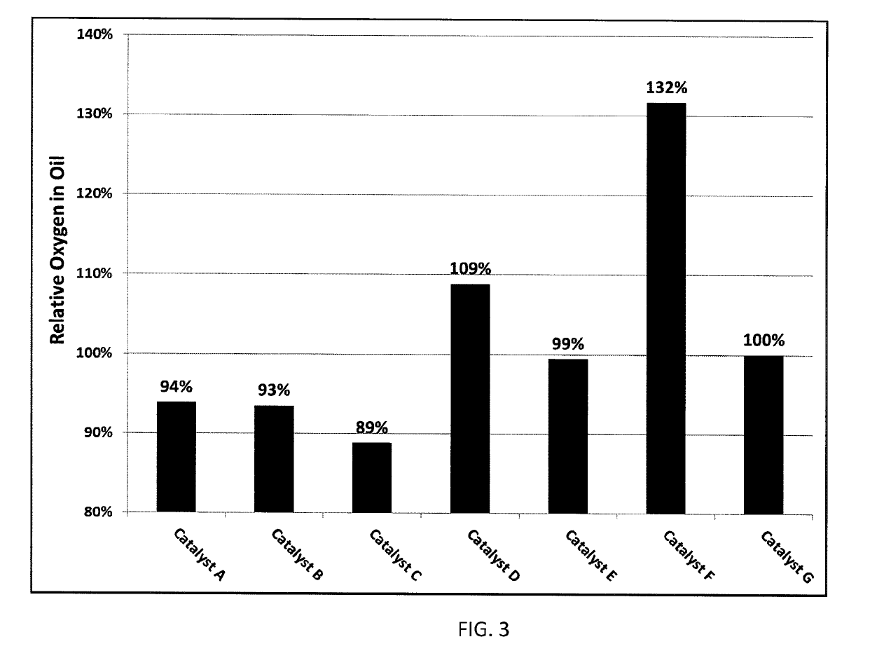

FIG. 3 is a plot of relative oxygen in bio-oil resulting from the above described biomass conversion runs for each of Catalysts A-G, all relative to the oxygen in bio-oil for Catalyst G. FIG. 3 shows superior or comparable deoxygenation activities for Catalysts A-E of the above-described embodiments as compared to commercially available FCC Catalyst G, while they all generate higher bio-oil yields than the Catalyst G. While the bio-oil yields for Catalysts A-E are slightly lower than that for the Base Case Catalyst F, the deoxygenation activities of Catalyst A-E are significantly better than the Base Case Catalyst F.

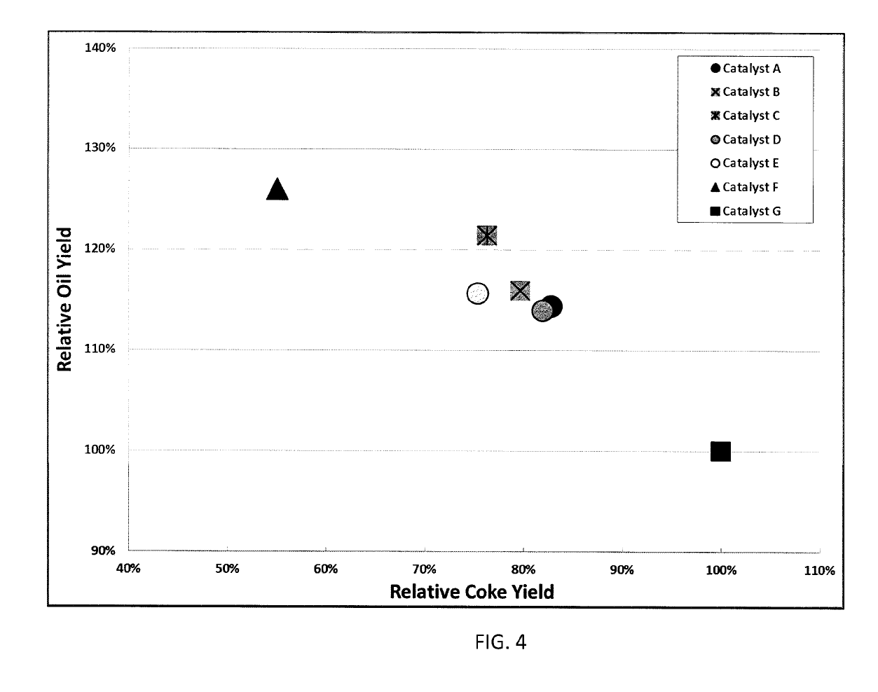

FIG. 4 is a plot of relative bio-oil yields vs. relative coke yields resulting from the above described biomass conversion runs for each of Catalysts A-G, all relative to the bio-oil yield and coke yield for Catalyst G. FIG. 4 shows the increase of the bio-oil yields and the decrease of the coke yields from the commercially available FCC Catalyst G to the Base Case Catalyst F, while the bio-oil yields and the coke yields for Catalysts A-E are tunable between Catalysts F and G.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

Further, unless expressly stated otherwise, the term “about” as used herein is intended to include and take into account variations due to manufacturing tolerances and/or variabilities in process control.

Changes may be made in the construction and the operation of the various components, elements and assemblies described herein, and changes may be made in the steps or sequence of steps of the methods described herein without departing from the spirit and the scope of the invention as defined in the following claims.

What is claimed is:

1. A method of preparing a biomass conversion catalyst comprising:
a) combining the following components in a mix vessel:
a phosphorous compound,
a zeolite,
a clay, and
an aqueous silica precursor to thereby form an aqueous slurry;
b) spray drying the aqueous slurry to thereby form spray dried particles; and
c) calcining the spray dried particles to thereby form the biomass conversion catalyst.

2. The method of claim 1 wherein the aqueous slurry comprises: in the range of from about 1 to about 20 wt % of the phosphorous compound, in the range of from about 10 to about 40 wt % of the zeolite, in the range of from about 30 to about 60 wt % of the clay, and in the range of from about 10 to about 30 wt % of the aqueous silica precursor.

3. The method of claim 1 wherein the zeolite comprises a member selected from the group consisting of: i) an 8 membered zeolite, ii) a 10 membered zeolite, iii) a 12 membered zeolite, iv) ZSM-5, v) USY, vi) mordenite, vii) ferrierite, viii) beta zeolite, and ix) mixtures thereof.

4. The method of claim 1 wherein the zeolite comprises ZSM-5.

5. The method of claim 1 wherein the aqueous silica precursor comprises silicic acid, polysilicic acid, and combinations thereof.

6. The method of claim 1 wherein the aqueous silica precursor is substantially sodium free.

7. The method of claim 1 wherein the phosphorous compound comprises a member selected from the group consisting of monoammonium phosphate, diammonium phosphate, phosphoric acid, and combinations thereof.

8. The method of claim 1 wherein the clay comprises kaolin clay.

9. The method of claim 1 wherein the calcining of the spray dried particles in step c) is at a temperature in the range of from about 300° C. to about 600° C.

10. The method of claim 1 wherein the biomass conversion catalyst comprises phosphorous promoted zeolite.

11. The method of claim 10 wherein the zeolite is promoted with phosphorous contained in the phosphorous compound to thereby form the phosphorous promoted zeolite.

12. The method of claim 1 wherein the biomass conversion catalyst is free of or substantially free of amorphous alumina.

13. The method of claim 1 wherein the biomass conversion catalyst comprises phosphated alumina.

14. The method of claim 13 wherein the clay comprises alumina and wherein the alumina of the clay reacts with phosphorous contained in the phosphorous compound to thereby form the phosphated alumina.

15. The method of claim 1 wherein the phosphorous compound is in the aqueous form and wherein the aqueous slurry is formed by:
i) adding the phosphorous compound to the mix vessel;
ii) adding the zeolite to the phosphorous compound in the mix vessel thereby forming a mixture A;
iii) adding the clay to the mixture A thereby forming a mixture B; and
iv) adding the aqueous silica precursor to the mixture B thereby forming the aqueous slurry of step a).

16. The method of claim 15 wherein the pH of the mixtures A and B are each from about 3 to about 7.

17. The method of claim 15 wherein the mixture A, or the mixture B, or both the mixture A and the mixture B is/are aged at a temperature of about 10 to about 50° C. for a period ranging from about 1 minute to about 24 hours.

18. The method of claim 15 wherein the pH of the aqueous slurry is from about 2 to about 4.

19. The method of claim 1 wherein the phosphorous compound is in the aqueous form and wherein the aqueous slurry is formed by:
i) adding the phosphorous compound to the mix vessel;
ii) adding the clay to the phosphorous compound in the mix vessel thereby forming a mixture C;
iii) adding the zeolite to the mixture C thereby forming a mixture D; and
iv) adding the aqueous silica precursor to the mixture D thereby forming the aqueous slurry of step a).

20. The method of claim 19 wherein the pH of the mixtures C and D are each from about 3 to about 7.

21. The method of claim 19 wherein the mixture C, or the mixture D, or both the mixture C and the mixture D is/are aged at a temperature of about 10 to about 50° C. for a period ranging from about 1 minute to about 24 hours.

22. The method of claim 19 wherein the pH of the aqueous slurry is from about 2 to about 4.

23. The method of claim 1 wherein the phosphorous compound is in the aqueous form and wherein the aqueous slurry is formed by:
i) combining a portion of the phosphorous compound with the zeolite outside of the mix vessel thereby forming a mixture E;
ii) combining a portion of the phosphorous compound with the clay outside of the mix vessel thereby forming a mixture F;
ii) combining the mixtures E and F in the mix vessel thereby forming a mixture G; and
iv) adding the aqueous silica precursor to the mixture G in the mix vessel thereby forming the aqueous slurry of step a).

24. The method of claim 23 wherein the pH of the mixtures E, F, and G are each from about 3 to about 7.

25. The method of claim 23 wherein the mixture E, or the mixture F, or both the mixture E and the mixture F is/are aged at a temperature of about 10 to about 50° C. for a period ranging from about 1 minute to about 24 hours.

26. The method of claim 23 wherein the pH of the aqueous slurry is from about 2 to about 4.

27. The method of claim 1 wherein the phosphorous compound is in the aqueous form and wherein the aqueous slurry is formed by:
i) adding the phosphorous compound to the mix vessel;
ii) combining a portion of the aqueous silica precursor with the zeolite outside of the mix vessel thereby forming a mixture H;
iii) combining a portion of the aqueous silica precursor with the clay outside of the mix vessel thereby forming a mixture I; and
iv) adding the mixtures H and I to the phosphorous compound in the mix vessel thereby forming the aqueous slurry.

28. The method of claim 27 wherein the pH of the mixtures H and I are each from about 2 to about 4.

29. The method of claim 27 wherein the mixture H, or the mixture I, or both the mixture H and the mixture I is/are aged at a temperature of about 0 to about 20° C. for a period ranging from about 1 minute to about 12 hours.

30. The method of claim 27 wherein the pH of the aqueous slurry is from about 2 to about 4.

31. A biomass conversion catalyst prepared by the method of claim 1.

32. A biomass conversion catalyst prepared by the method of claim 15.

33. A biomass conversion catalyst prepared by the method of claim 19.

34. A biomass conversion catalyst prepared by the method of claim 23.

35. A biomass conversion catalyst prepared by the method of claim 27.
